(19) United States
(12) Patent Application Publication
(10) Pub. No.: US 2026/0305866 A1
(43) Pub. Date: Oct. 8, 2026

(54) BEVERAGE DISPENSER AND SERIES OF BEVERAGE DISPENSERS

(71) Applicant: Jura Elektroapparate AG, Niederbuchsiten (CH)

(72) Inventors: Christoph GROB, Zofingen (CH); Daniel PAVLESIC, Deitingen (CH)

(73) Assignee: Jura Elektroapparate AG, Niederbuchsiten (CH)

(21) Appl. No.: 19/477,912

(22) PCT Filed: Feb. 20, 2024
(86) PCT No.: PCT/EP2024/054261

§ 371 Date: Oct. 23, 2025

(30) Foreign Application Priority Data
Apr. 25, 2023 (DE) 10 2023 110 527.2

(51) Int. Cl. A47J 31/52

(52) U.S. Cl. CPC A47J 31/52

(57) ABSTRACT

A beverage dispenser (1) having a plurality of instances (3a-3f) that are superimposed in a layer model of the beverage dispenser (1) and the various instances (3a-3f) can be replaced or expanded with the aid of functional lines (4) that are accessible from outside a housing (5) via a receptacle (18). The instances (3a-3f) are designed in such a way that a modular structure of the beverage dispenser (1) or a series of beverage dispensers with different variants is possible.

### CROSS-REFERENCE TO RELATED APPLICATIONS

This application is a 371 National Phase of International Application No. PCT/EP2024/054261, filed Feb. 20, 2024, which claims priority from German Patent Application No. 10 2023 110 527.2, both of which are incorporated herein by reference as if fully set forth.

### TECHNICAL FIELD

The invention relates to a beverage dispenser having a plurality of superimposed instances that are arranged one above the other in a layer model of the beverage dispenser, wherein at least one functional line connects the at least two instances. Such layer models are often used to present the design and function of such a fully automatic beverage dispenser in a function-oriented manner.

The invention also relates to the connection of the various instances by means of functional lines.

### BACKGROUND

The prior art discloses beverage vending machines, in particular fully automatic coffee machines, which integrate the various processing stages in a housing. The first stage is the interface to the operator, the stage below is a processor stage in which the recipes are processed in response to the operating commands of the top stage, and the stage below that is a driver stage that controls the actuators below it.

However, it is not possible to replace or expand one or more individual stages.

KR 2022 0114369 A discloses a storage unit for a capsule beverage extraction machine having a first capsule receiving part for receiving a capsule from which a beverage is extracted and a second storage unit having an opening hole in which the first capsule receiving part can be received.

CA 3 164 315 A further discloses an automated beverage dispensing system consisting of a housing having a main controller and in which each of a plurality of modular ingredient dispensers can be accommodated, each having a container with its own dispensing pump controlled by a main controller.

Furthermore, EP 3 302 184 B1 discloses a modular machine for preparing beverages from capsules, including a unit for supplying electrical and hydraulic power and a plurality of modules for the automatic preparation of beverages from capsules, each module being electrically and hydraulically autonomous with respect to every other module.

Furthermore, WO 02/059534 A1 discloses a network topology for communication within and between food service appliances, generally comprising one or more food service appliances, each of which includes a controller and at least one functional subsystem configured as a slave of the control unit, as well as a master interface and a bus slave interface connected to each controller.

Finally, WO 2011/135479 A1 discloses a modular system for preparing beverages. The system may comprise a base module with at least one water tank, an electrically operated boiler for heating the water, a water pump, an electronic controller, a user interface, and a coffee dispensing unit.

### SUMMARY

The invention is based on the object of creating an alternative to the structures commonly used to date.

To solve the aforementioned object, one or more of the features disclosed herein are provided according to the invention. In particular, a beverage dispenser of the type described at the beginning is proposed to solve the aforementioned object, in which the functional line is accessible from outside a housing of the beverage dispenser. This makes it possible to expand and/or replace instances of the beverage dispenser without having to replace it completely and/or, according to the invention, without having to open the housing.

Functional lines of a known type are suitable and/or designed, for example, for transmitting energy and/or signals such as control commands and/or status and analysis data and/or material flows such as water, coffee, milk, cleaning agents, or additives.

The connection between the instances can be implemented, for example, by means of a bus system. The bus system can be designed, for example, as a serial and/or parallel bus system.

An access point can be characterized, for example, by the fact an interface outside the housing, according to the invention, enables energy and signal transmission and/or a material flow into the interior or vice versa.

An access point can, for example, be designed as a commercially available interface such as mechanical adapters, electromechanical adapters, adapters with additional electronic circuits, or as a USB port.

In an advantageous design, it may be provided that the at least one functional line can be disconnected and/or bridged from the outside. This makes it possible to actively interrupt or divert the internal flow of energy, signals, and/or materials. This makes it possible to disconnect an instance from a circuit for replacement and to bypass the function via an external instance.

In an advantageous design, it may be provided that the at least one functional line has a branch leading to the outside. This enables serial or parallel supply and/or removal of energy, signals, and/or materials.

In an advantageous design, it may be provided that a first instance of the at least two instances is selected from the group consisting of an operating stage, a logic stage, a power stage, an actuator stage, a supply, for example a receptacle for unused material such as coffee beans, water, milk, and/or flavorings and/or sweeteners, and/or a receptacle for waste products such as pomace and/or residual water, and a beverage dispenser. This means that an exchange of the hierarchical stages is thus possible.

In an advantageous design, it may be provided that a second instance of the at least two instances is selected from the group consisting of an operating stage, the logic stage, the power stage, the actuator stage, the supply, and the beverage dispenser. This results in a modular structure that makes it possible to replace and/or expand the various stages, in particular very deeply located stages, in a beverage dispenser, in particular a coffee machine or, according to the invention, a fully automatic coffee machine.

The logic stage corresponds to the middle layer and contains all processing mechanisms. It combines the application logic and serves as an interface for operating and executing the underlying instances.

The logic stage can be characterized, for example, by executing the processing of the recipes in reaction to user input.

For example, this involves controlling the pump to supply liquid, switching the heating actuator on and off, commissioning the system, and/or putting the system into sleep mode. The logic stage also specifies the sequence of processes.

The power stage, as a low layer instance, contains all processing mechanisms and is responsible for the control of the further underlying actuator stage.

The power stage and logic stage may also differ in terms of their respective operating voltages. While the logic stage is mainly or exclusively operated with low voltage (5 V, 24 V, etc.), a voltage of over 100 V may be specified for the power stage.

In this case, it may be provided that the power stage may contain the memory (EEPROM) and drivers for controlling and forwarding signals, as well as phase angle control or other controls at the hardware level.

For example, the actuator can be the brewing device, a heating actuator, a pump device, or a motor drive for the grinder.

The sensors measure variables such as pressure, temperature, flow, fill level, force, weight, current, voltage, magnetism, light, movement, position changes, wear and tear, or combinations thereof.

For example, the storage container can be used to store one of the components for processing the recipes, in particular for storing unused material such as water, coffee, milk, or a similar component for producing cold and/or hot beverages. Further-more, the storage container can also serve as a receptacle for storing used material such as pomace, rinse water, or similar.

It is preferable for the beverage dispenser to be equipped with at least one outlet device.

In an advantageous design, it may be provided that the beverage dispenser comprises at least three instances and the third instance of the at least three instances is selected from the group consisting of the operating stage, the logic stage, the power stage, the actuator stage, the supply, and the beverage dispenser. This results in a modular structure that makes it possible to replace and/or expand the various stages, in particular very deep layers in a beverage dispenser, especially a coffee machine or, according to the invention, a fully automatic coffee machine.

In an advantageous design, it may be provided that the at least three instances can be connected and/or are connected in series and/or in parallel by respective functional lines. This allows for variable replacement and/or variable expansion in the further expansion stage. This ensures a high degree of flexibility, since direct addressing or direct access to the functional lines means that only the adjacent layer needs to be adapted and not the entire system.

In an advantageous design, it may be provided that the at least one functional line is accessible in the region of a receptacle in the housing. This allows for easy handling and expansion or replacement of instances without having to open the housing.

For example, the receptacle can be designed to serve as a holding device on the housing. In a further embodiment, an adapter or plug-in plate would also be conceivable as a holding device for the mechanical attachment of additional units.

In an advantageous design, it may be provided that the beverage dispenser may have a functional unit comprising at least one functional module, wherein the functional unit can be detachably mounted, preferably on the receptacle, to a base body of the beverage dispenser. This allows the functional unit to be variably replaced or supplemented.

For example, the functional unit comprising the functional module can be designed as a display unit, a container for storing components, or as a module of the various instances, for example, the logic stage, the power stage, and/or the actuator stage.

In an advantageous design, it may be provided that the receptacle may be designed so that the functional unit protrudes from the housing when assembled with the beverage dispenser. This allows the functional unit to be easily attached to the housing.

For example, the receptacle may be designed as a mobile or stationary holder.

In an advantageous design, it may be provided that the functional unit, in particular the at least one functional module, is connectable to at least two, preferably at least three, instances of the beverage dispenser by means of a respective functional line. This makes it possible at any time to subsequently add further instances to the beverage dispenser or to replace instances of the beverage dispenser without having to remove the original instances.

In an advantageous design, it may be provided that the at least one functional module is connectable to at least one second functional module, in particular several functional modules, of the functional unit. This makes it possible to expand the beverage dispenser in a modular manner and to supplement the requirements according to the wishes of the end user.

For example, the extension can be used to update the beverage dispenser with an additional control unit, an additional power stage and/or logic stage, or an extension of the actuator, or to adapt it to the individual needs of the end user.

In an advantageous design, it may be provided that the functional unit comprises an operating stage of the beverage dispenser, in particular wherein the operating stage has a display. This enables simple and intuitive operation and menu navigation of the beverage dispenser.

Well-known types of displays include OLED, LED, LCD, TFT, Retina, and AMOLED displays, which are used for the graphical representation of the menu navigation.

In an advantageous design, it may be provided that the functional module comprises at least one of the at least two instances. This enables simple, user-friendly expansion of the beverage dispenser with a functional module.

In an advantageous design, it may be provided that the functional module has a processor of the logic stage and/or a control unit of the power stage. This allows the operating system of the beverage dispenser to be bypassed in the event of failure of one of the instances, or enables the functional scope of the beverage dispenser to be expanded.

An example would be that new recipes are entered via the functional module, which requires the processing of control commands. For example, it is possible to skip heating the water before the brewing process and to carry out the brewing process with cold water. Another possibility would be, for example, to change the ratio of the components by modifying the control system and thus obtain a new recipe.

In an advantageous design, it may be provided that the functional unit may be provided with an accumulator for the beverage dispenser. This allows the beverage dispenser to be operated independently of an external power supply.

For example, the accumulator can be designed as primary cells (battery operation) or secondary cells (rechargeable battery operation).

In an advantageous design, it may be provided that the at least one functional line is an electrical line. This allows the signal and energy flow to take place via the functional line, thereby supplying the individual instances with the control commands, data, and energy.

In an advantageous design, it may be provided that the at least one functional line is a supply. This allows a flow of material to take place between the individual instances and to transport the components for producing a recipe to, for example, the brewing unit or the beverage dispensing unit.

In an advantageous design, it may be provided that the functional line can be bridged or is bridged by the functional unit. This allows the instances to be replaced without having to remove the previous instances from the housing or replace the beverage dispenser.

In an advantageous design, it may be provided that an interface of the functional line is led to a location on the housing that is accessible from the outside. This allows for simple, user-friendly expansion without having to open the housing of the beverage dispenser.

This makes it possible to expand the beverage dispenser without having the necessary technical expertise or without having to interfere with the architecture of the beverage dispenser.

For example, the accessible location can be designed as a plug, socket, adapter, connector, or valve.

In an advantageous design, it may be provided that the functional unit has at least one additional module with a cooling element and that the additional module can be attached or is attached in the region of the interface. This enables the components to be cooled, preventing them from spoiling quickly.

For example, the additional module can be used for the cooling storage of milk or another fluidic component.

It may be provided that the cooling element is designed as a Peltier element, for example.

In an advantageous design, it may be provided that the functional unit has a data carrier. This allows for easy integration of modified or new function and/or control commands.

It may be provided that, for example, the data carrier is designed as an electrostatic storage medium, in particular as a removable data carrier.

Additionally, the combination of features of the alternative independent claim directed to a series is proposed to solve the aforementioned object. In particular, it is proposed according to the invention that, in a series of beverage dispensers with at least two variants, a base body of the beverage dispenser is designed identically for each of the at least two variants and the functional units are designed differently. In this way, it is possible to manufacture a series of beverage dispensers, according to the invention, fully automatic coffee machines, in which the actual physical functional scope can be modified at the factory by installing a corresponding control unit or other unit. This enables individual adaptation to the requirements desired by the end user.

In an advantageous design, it may be provided that the differently designed functional units of the at least two variants differ in their functional modules. This makes it possible to create a series in which the physical functional ranges differ, thereby achieving a high degree of variability.

In an advantageous design, it may be provided that the differently designed functional units differ in the number of functional modules. This makes it possible to obtain a series with different expansion stages.

For example, it would be conceivable here that, by installing a corresponding operating unit or other units, the variants within the series differ in terms of their performance range and/or processing options.

In an advantageous design, it may be provided that the differently designed functional units differ in size. This allows the size requirements of the end user to be taken into account in the design.

In an advantageous design, it may be provided that the differently designed functional units differ in their shape. This means that the design requirements of the end user can be taken into account in the design. This enables the beverage dispenser to be individually designed to suit the needs of the end user.

In an advantageous design, it may be provided that the differently formed functional units differ in their operating stages. This allows a high degree of variability in the expansion and extension levels to be achieved.

In an advantageous design, it may be provided that the differently designed functional units can be detachably attached to the beverage dispenser at a receptacle. These can serve, for example, to bridge and/or bypass a bridging of, for example, the aforementioned functional line from outside the beverage dispenser. This makes it easy to modify individual components without requiring additional modifications to all coupled components.

Alternatively or additionally, the features of the alternative independent fourth claim directed to a beverage dispenser are provided according to the invention to solve the aforementioned object. In particular, to solve the aforementioned object in a beverage dispenser of the type described at the outset, it is proposed that the at least two instances are each designed as modules and are directly mechanically connected to each other, in particular without a frame. This results in a multitude of individual combination possibilities between the instances. Additional frame structures are unnecessary. This can also increase the design freedom for a designer.

For example, it is thus not necessary to install the various instances in a common support structure. Instead, the assembly can take place directly via mechanical connection, and the individual functional units can form or replace the independent frame-work of the beverage dispenser.

In an advantageous design, it may be provided that at least two, in particular at least three, instances may be selected from the group consisting of an operating stage, a logic stage, a power stage, an actuator stage, a supply, and a beverage dispenser. This allows for a simple and modular structure.

In an advantageous design, it may be provided that the at least three instances are each designed as modules and are directly mechanically connected to each other, wherein the three instances may be selected from the group consisting of an operating stage, a logic stage, a power stage, an actuator stage, a supply, and a beverage dispenser. This makes it easy to change individual components, as the changes only affect the respective component locally and have no impact on the other components.

In an advantageous design, it may be provided that the at least two modules are detachably connected to each other. This allows one or more modules to be easily replaced.

The connections can be designed, for example, as screw connections or plug connections. Force-fit, form-fit, materially bonded and/or magnetic connections can also be used.

In an advantageous design, it may be provided that at least two, preferably all, modules have a functional line. This allows a signal/energy flow and/or material flow to take place via the respective modules.

In an advantageous design, it may be provided that the functional lines for signal and/or energy flow are designed to be contactless. This means that cabling of the individual modules is not necessary. For example, the material/energy flow can be inductive or via RFID.

In an advantageous design, it may be provided that at least one, preferably all, modules are designed as removable functional units. This allows for easy replacement or expansion of the modules without having to replace or modify the other modules.

In an advantageous design, all possible functions are already stored at the logic stage. When a module is inserted, the logic stage recognizes it and knows how to use the module.

In an advantageous design, it may be provided that the information of the modules is stored on the logic stage and that, when inserted, the logic stage recognizes and controls the modules. This means that the beverage dispensers can be easily and inexpensively expanded and operated with additional functional modules at a later date.

### BRIEF DESCRIPTION OF THE DRAWINGS

The invention is now described in more detail with reference to exemplary embodiments, but is not limited to these exemplary embodiments. Further exemplary embodiments result from combining the features of individual or multiple claims with each other and/or with individual or multiple features of the exemplary embodiments, wherein:

FIG. 1 shows a schematic representation of a beverage dispenser known from the prior art,

FIG. 2 shows a schematic representation of a beverage dispenser according to the invention,

FIG. 3 shows a schematic representation of a beverage dispenser according to the invention in a further stage of development,

FIG. 4 shows a schematic representation of a beverage dispenser according to the invention, designed as a module,

FIG. 5 shows a schematic representation of a product platform and an extension thereof, and

FIG. 6 shows a schematic representation of a modular design.

### DETAILED DESCRIPTION

FIG. 1 shows a beverage dispenser known from the prior art, designated in its entirety by reference sign 1. In the example, the beverage dispenser 1 is designed as a fully automatic coffee machine 2 with a housing 5.

The beverage dispenser 1 is designed in a manner known per se according to a layer model and comprises various instances 3a-3f.

The top instance 3a, the operating stage 6, is designed to represent the data and user inputs and as a user interface with a graphical user interface.

The subordinate instance 3b, the logic stage 7, stores the processes and menu structures for processing the various commands.

The application logic with the memories and drivers is located in the lower instance 3c, the power stage 8. It contains all processing mechanisms for controlling the actuators and sensors located in the lowest instance.

The individual instances are connected to each other via functional lines 4 so that a signal/energy flow 12 can take place between the instances.

Further instances 3e and 3f comprise a supply 10 for storing one of the components, such as water, milk, or coffee, and a beverage dispensing unit 11.

Via instance 3d, the actuator stage 9, the flow of material 13 from the components in the supply 10 is triggered to the instance of the beverage dispensing unit 11.

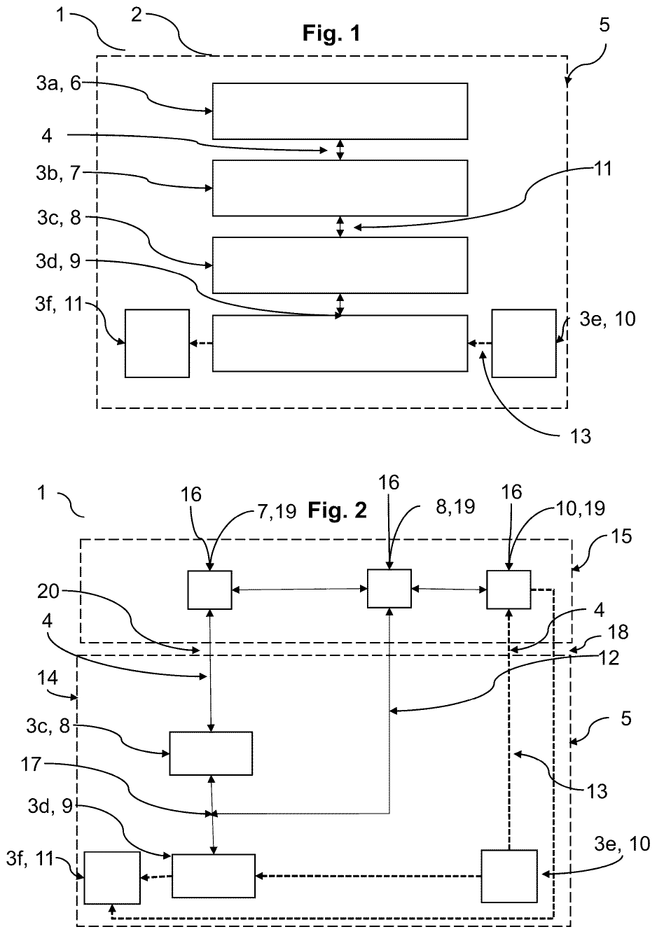

FIG. 2 shows a schematic representation of an embodiment of the beverage dispenser 1 according to the invention.

In addition to the platform 14 of the beverage dispenser 1, the representation shows a functional unit 15 which can serve, for example, as an extension 19 of the platform 14.

The platform 14 consists of an instance 3a-3f or a combination of instances 3a-3f from the group of operating stage 6, logic stage 7, power stage 8, actuator stage 9, supply 10, and beverage dispenser 11.

The structure is shown only as an example to explain the invention. In further exemplary embodiments, instances may be combined or omitted, and/or additional instances may be formed.

In FIG. 2, the platform 14 is formed with instances 3a-3f of logic stage 7, actuator level 9, supply 10, and beverage dispenser 11.

The functional unit 15 has at least one functional module 16. The functional module 16 can, for example, consist of an instance 3a-3f or a combination of instances 3a-3f from the group of the operating stage 6, the logic stage 7, the power stage 8, the actuator stage 9, the supply 10, and the beverage dispenser 11.

FIG. 2 of the exemplary embodiment shows a functional unit 15 with an additional extended functional module 16 of logic stage 7, as well as extensions 19 of power stage 8 and actuator stage 9.

The functional line 4 is accessible from outside the housing 5 of the beverage dispenser 1. In the example, the functional line 4 can be an electrical line or a supply The functional line 4 has an outwardly leading branch 17 and is accessible from the outside via this branch.

It may be provided, for example in the functional line 4, which is led from the supply 10 via the logic stage 7 of the extension 19 to the beverage dispensing unit 11, that the functional line 4 can be disconnected or bridged from the outside in order to connect the instances 3a-3f.

The functional unit 15, in particular one of the functional modules 16, is connected to at least two instances 3a-3f of the platform 14 by one or more functional lines 4. The functional lines 4 are accessible in the region of the housing 5 via a receptacle 18, so that the instances 3a-3f of the platform 14 can be coupled with the functional modules 16 of the functional unit 15 of the extension 19.

An energy/signal flow 12 and/or a material flow 13 takes place between the platform 14 and the functional unit 15 via the functional line 4.

In the exemplary embodiment shown in FIG. 2, the material flow 13 is first guided from the supply 10 via the functional module 16 and the functional unit 15 and then to the beverage dispensing device 11. In this example, the functional module 16 is designed as an extension 19 of the actuator stage 9 so that, for example, a different or additional processing of the components for beverage production can be carried out.

The logic stage 7 has only been integrated into the functional unit 15 as functional module 16 and is connected via the functional line 4 both to the instances 3a-3f of the platform 14 and to the other functional modules 16 of the functional unit 15.

The functional lines 4 have interface 20, which can be disconnected or bridged from the outside, so that the internal energy/signal flow 12 and/or material flow 13 can be interrupted and/or diverted via the functional unit 15.

The interface 20 is located at a point on the housing 5 that is accessible from the outside.

In the exemplary embodiment shown in FIG. 2, the signal and energy flow 12 of the power stage 8 is diverted to the extension 19 of the power stage 8, so that the actuator stage 9 is controlled via the extension 19 of the power stage 8 of the extension 19.

A branch 17 leads the functional line 4 to the outside, so that serial or parallel control of the various instances 3a-3f is possible.

FIG. 3 shows another exemplary embodiment according to the invention. Components and functional units that are functionally and/or structurally similar or identical to those in the preceding exemplary embodiments are designated by the same reference signs and are not described separately again.

The exemplary embodiment of FIG. 3 is constructed from a platform 14 and a functional unit 15 with several functional modules 16 of instances 3a-3f.

In the example shown in FIG. 3, the functional unit 15 has an operating stage 6 as a functional module 16, in each case an extension 19 of the operating stage 6, the logic stage 7, the power stage 8, and the actuator stage 9.

The functional module 16 of the extension 19 of the logic stage 7 can be designed with a processor, for example.

In this example, the extension 19 of the power stage 8 is designed with a control unit 24.

In an exemplary embodiment not shown, the functional unit 15 has an accumulator of the beverage dispenser 1.

In the exemplary embodiment shown in FIG. 3, the various instances are coupled via functional unit 15. The functional lines 4 of signal and energy flow 12 are blocked within instances 3a-3f of platform 14 and become functional modules 16 of functional unit 15. As a result, there is no energy/signal flow 12 between the individual instances 3a-3f within the platform 14, but is carried out exclusively via the functional modules 16 of the functional unit 15. The functional unit 15 thus takes over or supplements the signal/energy flow 12 of the platform 14.

The signal/energy flow 12 can be carried out both serially and in parallel between the instances of the platform 14 and the functional unit 15.

The functional unit 15 can be accessed via a receptacle 18 in the housing 5. In an embodiment not shown, the functional unit 15 is detachably attached to the receptacle 18 with a functional module 16.

The receptacle 18 is designed so that the functional unit 15 protrudes from the housing 5 when assembled with the beverage dispenser 1.

The functional unit 15, in particular the functional module 16, can be connected to at least two of the instances 3a-3f of the beverage dispenser 1 via the functional line 4.

In an example not shown, the functional unit 15 may comprise, for example, a display, an accumulator, or a data carrier. Furthermore, it is possible that the functional unit 15 comprises a cooling element as a further functional module 16.

In the exemplary embodiment shown in FIG. 3, the material flow 13 is bridged via the functional unit 15. The supply 10, in the form of a component for preparing beverages, is fed via a functional line 4 to the extension 19 of the actuator stage 9 and, after appropriate pre-treatment and/or preparation, is fed via the actuator stage 9 of the platform 14 to the beverage dispensing unit 11.

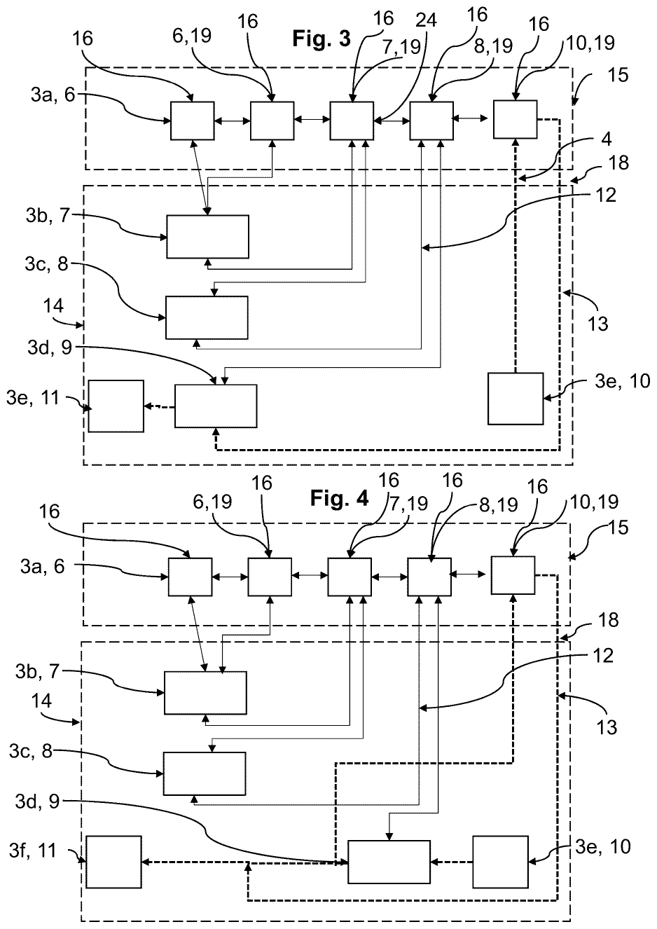

FIG. 4 shows another exemplary embodiment according to the invention. Components and functional units that are functionally and/or structurally similar or identical to those in the preceding exemplary embodiments are designated with the same reference signs and are not described separately again. The explanations relating to the preceding exemplary embodiments apply accordingly.

The exemplary embodiment according to FIG. 4 differs from the preceding exemplary embodiments at least in that the coupling between the platform 14 and the functional unit 15 is designed in such a way that the material flow 13 can take place in parallel via both the platform 14 and the extension 19.

For example, the components can be modified or additional components can be added for new formulations. In this context, it is conceivable, for example, to add new substances or to thermally or otherwise treat the fluid or its components using additional modules.

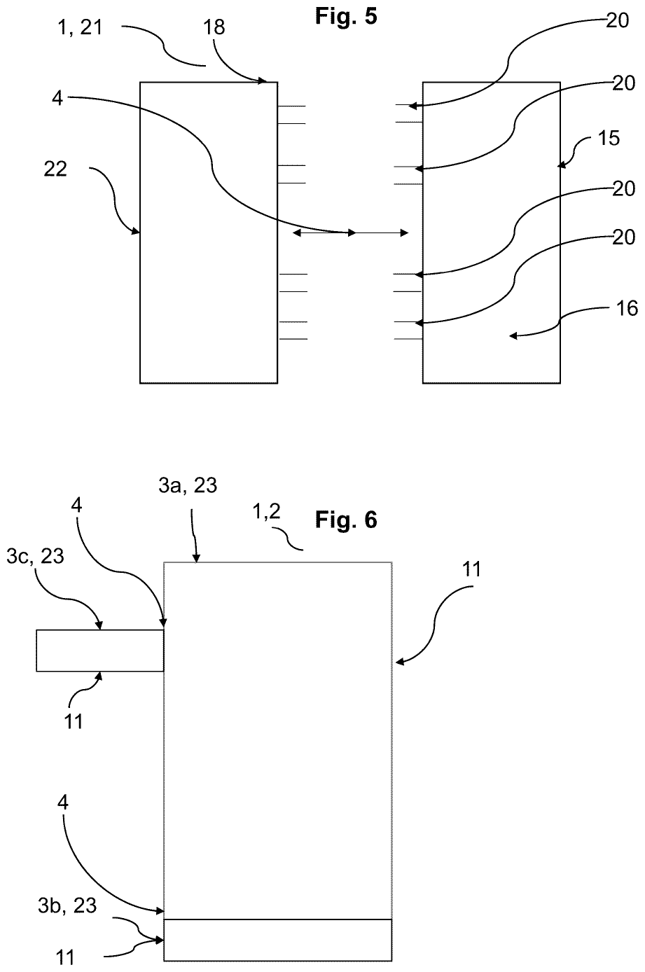

FIG. 5 shows another exemplary embodiment according to the invention. Components and functional units that are functionally and/or structurally similar or identical to those in the preceding exemplary embodiments are designated with the same reference signs and are not described separately again. The explanations relating to the preceding exemplary embodiments apply accordingly.

The exemplary embodiment in FIG. 5 shows a schematic representation of a series 21 of a beverage dispenser 1. The series 21 is characterized, for example, in that there are at least two different variants of the expansion stage.

The variants of the series 21 are each constructed from a base body 22 and a functional unit 15. The base body 22 of the series 21 is always constructed in the same way, but the functional units 15 differ, for example, in their appearance, particularly in size and shape, in their functional modules 16, and/or in the number of functional modules 16 and in their operating stages.

The differently configured functional units 15 can be detachably attached to the receptacle 18 of the base body 22.

FIG. 6 shows a schematic representation of a modular structure of a beverage dispenser 1.

In the exemplary embodiment shown in FIG. 6, instances 3a-c are designed as detachable modules 23 on top of and/or next to each other and are mechanically connected to each other on a frameless support structure that is not shown. The modules 23 can, for example, be formed as instances 3a-3f from the group comprising the operating stage 6, logic stage 7, power stage 8, actuator stage 9, supply 10, or beverage dispensing stage 11. There are various possible combinations of two, three, or more modules 23.

An additional support structure, frame, or the like is not required.

The modules 23 are connected to each other via at least one functional line 4. The modules 23 can also be designed as a functional unit 15.

In an example not shown, the information from the modules 23 may already be available at logic stage 7, so that when the module 23 is added, it can be directly recognized and controlled by logic stage 7.

The functional line 4 for the signal and/or energy flow can be designed to be contactless.

The invention relates to a beverage dispenser 1 having a plurality of instances 3a-3f, which are superimposed in a layer model of the beverage dispenser 1 and the various instances 3a-3f can be replaced or expanded with the aid of functional lines 4, which are accessible from outside a housing 5 via a receptacle 18. The invention further relates to the fact that the instances 3a-3f are designed in such a way that a modular structure of the beverage dispenser 1 or a series of beverage dispensers with different variants is possible.

### LIST OF REFERENCE SIGNS

1 Beverage dispenser
2 Fully automatic coffee machine
3a Instance
3b Instance
3c Instance
3d Instance
3e Instance
3f Instance
4 Functional line
5 Housing
6 Operating stage
7 Logic stage
8 Power stage
9 Actuator stage
10 Supply
11 Beverage dispensing unit
12 Signal/energy flow
13 Material flow
14 Platform
15 Functional unit
16 Functional module
17 Branch
18 Receptacle
19 Extension
20 Interface
21 Series
22 Base body
23 Module

1. A beverage dispenser (1), designed as a fully automatic coffee machine (2), comprising:
a housing (5);
at least two instances (3a, 3b) which are superimposed in a layer model of the beverage dispenser (1);
at least one functional line (4) connects the at least two instances (3a, 3b), the at least one functional line (4) is accessible from outside the housing (5) of via an interface (20) without having to open the housing (5); and
an energy or signal transmission and/or material flow (13) to the inside or vice-versa is enabled via the interface (20).

2. The beverage dispenser (1) according to claim 1, wherein the at least one functional line (4) has a branch (17) leading to the outside of the housing.

3. The beverage dispenser (1) according to claim 1, wherein the at least one functional line (4) is adapted to be disconnected and/or bridged from the outside of the housing.

4. The beverage dispenser (1) according to claim 1, wherein at least one of a) a first instance (3a) of the at least two instances (3a-3f) is selected from the group consisting of an operating stage (6), a logic stage (7), a power stage (8), an actuator stage (9), a supply (10), and a beverage dispenser (11), or b) a second instance (3b) of the at least two instances (3a-3f) is selected from the group consisting of an operating stage (6), a logic stage (7), a power stage (8), an actuator stage (9), a supply (10) and a beverage dispenser (11).

5. The beverage dispenser (1) according to claim 4, wherein there are at least three of the instances (3a-3f), and the third instance (3c) of the at least three instances (3a-3f) is selected from the group consisting of the logic stage (7), the power stage (8), the actuator stage (9), the supply (10) and the beverage dispenser (11), and/or wherein the at least three instances are adapted to be connected in series or in parallel by respective ones of the functional lines (4).

6. The beverage dispenser (1) according to claim 5, wherein the at least one functional line (4) is accessible in a region of a receptacle (18) of the housing (5), and/or wherein the beverage dispenser (1) further comprises a functional unit (15) comprising at least one functional module (16), wherein the functional unit (15) is receivable at the receptacle (18), with a platform (14) of the beverage dispenser (1).

7. The beverage dispenser (1) according to claim 6, wherein the receptacle (18) is designed so that the functional unit (15) protrudes from the housing (5) when assembled with the beverage dispenser (1).

8. The beverage dispenser (1) according to claim 6, wherein the functional unit (15), is connectable to at least two of the instances (3a-3fc) by a respective one of the functional lines (4), and/or the at least one functional module (16) is connectable to at least one second functional module (16) of the functional unit (15).

9. The beverage dispenser (1) according to claim 8, wherein the functional unit (15) comprises an operating stage (6) of the beverage dispenser (1.

10. The beverage dispenser (1) according to claim 6, wherein the functional module (16) comprises at least one of the at least two instances (3a-3f), and/or the functional module (16) has at least one of a processor of the logic stage (7) or a control unit of the power stage (8).

11. The beverage dispenser (1) according to claim 6, wherein the functional unit (15) has an accumulator.

12. The beverage dispenser (1) according to claim 1, wherein the at least one functional line (4) is at least one of an electrical line or a supply (10).

13. The beverage dispenser (1) according to claim 6, wherein the at least one functional line (4) is adapted to be bridged or is bridged by the functional unit (15), and/or the interface (20) of the functional line (4) is led to a location on the housing (5) that is accessible from the outside.

14. The beverage dispenser (1) according to claim 6, wherein the functional unit (15) has at least one additional module, and the additional module is adapted to be attached or is attached in a region of the interface (20).

15. The beverage dispenser (1) according to claim 6, wherein the functional unit (15) has a data carrier.

16. A series (21) of beverage dispensers (1) comprising at least two variants of the beverage dispensers, wherein each variant the beverage dispenser (1) according to claim 1, and a base body (22) of the beverage dispensers (1) is designed identically for the at least two variants and functional units (15) of the beverage dispensers (1) are designed differently.

17. The series (21) according to claim 16, wherein the differently designed functional units (15) of the at least two variants differ in a type of the functional modules (16) and/or in a number of functional modules (16).

18. The series (21) according to claim 16, wherein the differently designed functional units (15) differ in an external appearance.

19. The series (21) according to claim 16, wherein the differently designed functional units (15) differ in operating stages (6).

20. The series (21) according to claim 16, wherein the differently designed functional units (15) are adapted to be detachably attached to the base body (22) of the respective beverage dispenser (1).

21. A beverage dispenser (1), designed as a fully automatic coffee machine (2), comprising:
at least two instances (3a-3f) which are located one above the other and/or next to each other in a layer model of the beverage dispenser (1), wherein the at least two instances (3a-3f) are each designed as a module (23) and are directly mechanically connected to each other in a frameless manner.

22. The beverage dispenser (1) according to claim 21, wherein the beverage dispenser (1) has at least three of the instances (3a-3f), the at least three instances (3a, 3b, 3c) are each designed as a module (23) and are directly mechanically connected to each other, and the at least three instances (3a, 3b, 3c) are selected from the group consisting of an operating stage (6), a logic stage (7), a power stage (8), an actuator stage (9), a supply (10), and a beverage dispenser (25).

23. The beverage dispenser (1) according to claim 21, wherein the at least two modules (23) are detachably and/or framelessly connected to each other.

24. The beverage dispenser (1) according to claim 21, wherein at least two of the modules (23) have a functional line (4).

25. The beverage dispenser (1) according to claim 24, wherein the functional lines (4) are for signal and/or energy flow (12) and are designed to be contactless.

26. The beverage dispenser (1) according to claim 21, wherein at least one of the modules (23) is designed as a removable functional unit (11).

27. The beverage dispenser (1) according to claim 21, wherein information relating to the modules (23) is stored on logic stage (7) and the information is adapted to be identified and controlled by the logic stage (7) when added.
